(19) United States
(12) Patent Application Publication
(10) Pub. No.: US 2006/0107290 A1
(43) Pub. Date: May 18, 2006

(54) Digital broadcasting receiving device and electronics apparatus having a common AV circuit board

(75) Inventors: Takayuki Kado, Takefu-city (JP); Katsushi Yamashita, Takefu-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Takefu-city (JP)

(21) Appl. No.: 11/258,139

(22) Filed: Oct. 26, 2005

(30) Foreign Application Priority Data
Oct. 29, 2004 (JP) 2004-315885

(51) Int. Cl. H04N 5/445

(52) U.S. Cl. 725/38

(57) ABSTRACT

The invention provides a digital broadcasting receiving device for receiving digital broadcasting and an electronics apparatus having a common AV circuit board used for a digital circuit board capable of receiving a charging broadcast and a digital circuit board incapable of receiving the charging broadcast so that the cost can be reduced. A circuit configuration of an AV circuit board 10 is rendered compatible and common with multiple digital circuit boards 20 and 30, and a projection on an upside of a vertical tuner 26 mounted on the digital circuit board 20 incapable of receiving the charging broadcast placed on a downside is shaped like a notch by providing a split board 14 on a corner of the AV circuit board 10 contacting the projection of the vertical tuner 26 so that the AV circuit board 10 and the digital circuit board 20 can be placed in two-layer placement.

The present application is based on and claims priority of Japanese patent application No. 2004-315885 filed on Oct. 29, 2004, the entire contents of which are hereby incorporated by reference.

### BACKGROUND OF THE INVENTION

1. Field of the Invention

The present invention relates to a digital broadcasting receiving device and an electronics apparatus having a common AV (Audio and Visual) circuit board, wherein the digital broadcasting receiving device for receiving digital broadcasting has a common AV circuit board used for a digital circuit board capable of receiving charging broadcast and a digital circuit board incapable of receiving the charging broadcast so that there is no need to manufacture multiple kinds of the AV circuit board and electronic components mounted on the AV circuit board are also rendered common so as to allow improvement in efficiency of material control of the electronic components and mounting work of the AV circuit board and allow cost reduction.

2. Description of the Related Art

Conventionally, to receive a charging broadcast, a receiving device for receiving digital broadcasting has multiple kinds of AV circuit board designed specifically for a digital circuit board having a charging broadcast receiving portion placed thereon and a digital circuit board incapable of receiving the charging broadcast respectively. Therefore, it is necessary to produce multiple kinds of the AV circuit board based on the design, and so it requires a design load for designing the multiple kinds of AV circuit board, a parts management load due to increased kinds of electronic components, a mounting load for mounting the multiple kinds of AV circuit board, and further a quality control load for controlling and maintaining quality of the multiple kinds of AV circuit board and an assembly work load due to combinations of the multiple kinds of AV circuit board with the multiple kinds of digital circuit board, where these loads are a factor in increasing costs. In general, the digital circuit board often uses a multilayer board material laminated approximately in six layers, and an effort is made to reduce the area using the multilayer board material as much as possible because of its high cost.

For instance, as a conventional technology according to Japanese Patent Laid-Open Publication No. 2003-61009 (Patent Document 1), such a digital broadcasting receiving device consists of a first board for mounting circuit components mutually common to a digital television and a digital television set-top box, a second board for mounting circuit components according to their respective uses, and a connection wiring element for electrically connecting the first and second boards mutually. The first board has a tuner and a digital processing circuit for digitally processing a signal received by the tuner, and also has connections to be connected to the connection wiring element respectively on one marginal portion to be shared by the digital television and digital television set-top box. One marginal portion of the second board has the connections to be connected to the connection wiring element respectively so as to be incorporated in the receiving devices of different uses. Thus, it discloses a method for providing a board wiring element for improving design efficiency and reducing the number of components as a whole.

### SUMMARY OF THE INVENTION

According to the present invention, a receiving device for receiving digital broadcasting in the conventional technology has an AV circuit board designed, which is usable in common for a digital circuit board capable of receiving a charging broadcast and a digital circuit board incapable of receiving the charging broadcast It is thus possible, just by producing the AV circuit board usable in common based on the design, to eliminate the need for a design load for designing multiple kinds of AV circuit board, a parts management load due to increased kinds of electronic components, amounting load for mounting the multiple kinds of AV circuit board, and further a quality control load for controlling and maintaining quality of the multiple kinds of AV circuit board and reduce an assembly work load due to combinations of the multiple kinds of AV circuit board and multiple kinds of digital circuit board so as to obtain a digital broadcasting receiving device and an electronics apparatus having a common AV circuit board capable of reducing costs due to the loads.

A digital broadcasting receiving device and an electronics apparatus having a common AV circuit board according to a first aspect are the ones wherein: multiple kinds of digital circuit board are combined and connected with the AV circuit board including a power supply portion for supplying power to mounted electronic components, a jack portion having jacks used for connections with other electronics apparatuses, a signal switching portion for selecting a predetermined video and audio signal from an analog video and audio signal and a digital video and audio signal inputted from the jack portion, and an audio switching portion for selecting a predetermined audio signal from an analog audio signal and a digital audio signal inputted from the signal switching portion so as to configure multiple kinds of digital broadcasting receiving circuit; and the AV circuit board has a separable split board placed at a corner thereof, and in the case of configuring a circuit in two-layer placement with the digital circuit board incapable of receiving a charging broadcast and having a vertical tuner placed thereon on a downside and the AV circuit board on an upside, they are placed and combined to have the vertical tuner placed on the digital circuit board on the downside incapable of receiving the charging broadcast projected from a notch portion at which the split board is separated and electrically connected for circuit configuration so as to configure the digital broadcasting receiving circuit incapable of receiving the charging broadcast; and

a digital circuit board including a charging broadcast receiving portion and having a horizontal tuner placed thereon capable of receiving the charging broadcast is combined and electrically connected with the AV circuit board having the split board to overlap each other so as to configure the digital broadcasting receiving circuit capable of receiving the charging broadcast; and a digital interface portion including a connection function for digital connections with other electronics apparatuses, a video correcting portion for correcting a video signal inputted from the signal switching portion and a microcomputer portion for controlling the portions are placeable on one of the AV circuit board, the digital circuit board incapable of receiving the charging broadcast and the digital circuit board capable of receiving the charging broadcast.

According to the configuration of the first aspect, the digital broadcasting receiving device and electronics apparatus having a common AV circuit board can combine and connect multiple kinds of digital circuit board with the AV circuit board including a power supply portion for supplying power to mounted electronic components, a jack portion having jacks used for connections with other electronics apparatuses, a signal switching portion for selecting a predetermined video and audio signal from an analog video and audio signal and a digital video and audio signal inputted from the jack portion, and the audio switching portion for selecting a predetermined audio signal from an analog audio signal and a digital audio signal inputted from the signal switching portion so as to configure multiple kinds of digital broadcasting receiving circuit; and the AV circuit board has a separable split board placed at a corner thereof, and in the case of configuring a circuit in two-layer placement with the digital circuit board incapable of receiving a charging broadcast and having a vertical tuner placed thereon on a downside and the AV circuit board on an upside, they can be placed and combined to have the vertical tuner placed on the digital circuit board on the downside incapable of receiving the charging broadcast projected from a notch portion at which the split board is separated and electrically connected for circuit configuration so as to configure the digital broadcasting receiving circuit incapable of receiving the charging broadcast. It is possible to combine and electrically connect a digital circuit board including a charging broadcast receiving portion and having a horizontal tuner placed thereon capable of receiving the charging broadcast with the AV circuit board having the split board to overlap each other so as to configure the digital broadcasting receiving circuit capable of receiving the charging broadcast. The digital interface portion including a connection function for digital connections with other electronics apparatuses, video correcting portion for correcting a video signal inputted from the signal switching portion, and microcomputer portion for controlling the portions are placeable on one of the AV circuit board, the digital circuit board incapable of receiving the charging broadcast and the digital circuit board capable of receiving the charging broadcast.

The digital broadcasting receiving device and electronics apparatus having a common AV circuit board according to a second aspect are the ones according to the first aspect wherein: the digital circuit board incapable of receiving the charging broadcast includes: a power supply portion for supplying power to the digital circuit board; a vertical analog/digital tuner for converting received signals of analog broadcasting and digital broadcasting to the analog video and audio signal and digital video and audio signal; a signal converting portion for converting the analog video signal inputted from the video correcting portion placed on the AV circuit board to the digital video signal; an image processing portion for decoding the video and audio signal of the digital broadcasting and adjusting a size of an image of the video signal; a first memory used by the image processing portion to store an OS and software; a second memory for replacing a work area of the software and video stored in the first memory; and a jack portion having jacks used for connections with other digital electronics apparatuses placed thereon so as to be electrically connected to the AV circuit board and thereby configure the digital broadcasting receiving circuit incapable of receiving the charging broadcast.

According to the configuration of the second aspect, the digital circuit board incapable of receiving the charging broadcast includes: a power supply portion for supplying power to the digital circuit board; a vertical analog/digital tuner for converting received signals of analog broadcasting and digital broadcasting to the analog video and audio signal and digital video and audio signal; a signal converting portion for converting the analog video signal inputted from the video correcting portion placed on the AV circuit board to the digital video signal; an image processing portion for decoding the video and audio signal of the digital broadcasting and adjusting a size of an image of the video signal; a first memory used by the image processing portion to store an OS and software; a second memory for replacing a work area of the software and video stored in the first memory; and a jack portion having jacks used for connections with other digital electronics apparatuses placed thereon so as to be electrically connected to the AV circuit board and thereby configure the digital broadcasting receiving circuit incapable of receiving the charging broadcast. Thus, it is possible to easily obtain the digital broadcasting receiving device and electronics apparatus having a common AV circuit board incapable of receiving the charging broadcast.

The digital broadcasting receiving device and electronics apparatus having a common AV circuit board of a third aspect are the ones according to the first aspect wherein: the digital circuit board capable of receiving the charging broadcast includes:

a power supply portion for supplying power to the digital circuit board; a horizontal analog/digital tuner for converting received signals of analog broadcasting and digital broadcasting to the analog video and audio signal and digital video and audio signal; a charging broadcast receiving portion for decoding the charging broadcast including an inserting portion of a user card for the charging broadcast; a signal converting portion for converting an analog video signal inputted from a video correcting portion placed on the AV circuit board to a digital video signal; an image processing portion for decoding the video and audio signal of the digital broadcasting and adjusting a size of an image of the video signal; a first memory used by the image processing portion to store an OS and software; a second memory for replacing a work area of the software and video stored in the first memory; and a jack portion having jacks used for connections with other digital electronics apparatuses placed thereon so as to be electrically connected to the AV circuit board and thereby configure the digital broadcasting receiving circuit capable of receiving the charging broadcast.

According to the configuration of a third aspect, the digital circuit board capable of receiving the charging broadcast includes: a power supply portion for supplying power to the digital circuit board; a horizontal analog/digital tuner for converting received signals of analog broadcasting and digital broadcasting to the analog video and audio signal and digital video and audio signal; a charging broadcast receiving portion for decoding the charging broadcast including an inserting portion of a user card for the charging broadcast; a signal converting portion for converting an analog video signal inputted from a video correcting portion placed on the AV circuit board to a digital video signal; an image processing portion for decoding the video and audio signal of the digital broadcasting and adjusting a size of an image of the video signal; a first memory used by the image processing portion to store an OS and software; a second memory for replacing a work area of the software and video stored in the first memory; and a jack portion having jacks used for connections with other digital electronics apparatuses placed thereon so as to be electrically connected to the AV circuit board and thereby configure the digital broadcasting receiving circuit capable of receiving the charging broadcast. Thus, it is possible to easily obtain the digital broadcasting receiving device and electronics apparatus having a common AV circuit board capable of receiving the charging broadcast.

### BRIEF DESCRIPTION OF THE DRAWINGS

FIG. 1 is a block diagram showing a configuration of an AV circuit board indicating a first embodiment of the present invention;

FIG. 2 are a plan schematic diagram and a side schematic diagram showing a positional relation in which the AV circuit board and a digital circuit board incapable of receiving a charging broadcast are combined and placed according to the first embodiment of the present invention;

FIG. 3 is a block schematic diagram showing a configuration of the digital circuit board incapable of receiving the charging broadcast according to the first embodiment of the present invention;

FIG. 4 are a plan schematic diagram and a side schematic diagram showing a positional relation in which the AV circuit board and a digital circuit board capable of receiving a charging broadcast are combined and placed, indicating a second embodiment of the present invention;

FIG. 5 is a block diagram showing a configuration of the digital circuit board capable of receiving the charging broadcast according to the second embodiment of the present invention; and

FIG. 6 is a block diagram showing a circuit configuration of a digital television having the AV circuit board and the digital circuit board capable of receiving the charging broadcast placed therein according to the second embodiment of the present invention.

### DETAILED DESCRIPTION OF THE PREFERRED EMBODIMENTS

As described above, in essence, the present invention uses a common AV circuit board for a digital circuit board capable of receiving a charging broadcast and a digital circuit board incapable of receiving the charging broadcast in a digital broadcasting receiving device for receiving digital broadcasting so as to obtain the digital broadcasting receiving device having a common AV circuit board and an electronics apparatus also having it, wherein there is no need to manufacture the desired multiple kinds of the AV circuit board and electronic components mounted on the AV circuit board are also rendered common to allow improvement in efficiency of material control of the electronic components and mounting work of the AV circuit board and allow cost reduction. The following will describe the embodiments of the multiple digital circuit boards, the common AV circuit board and a television including them.

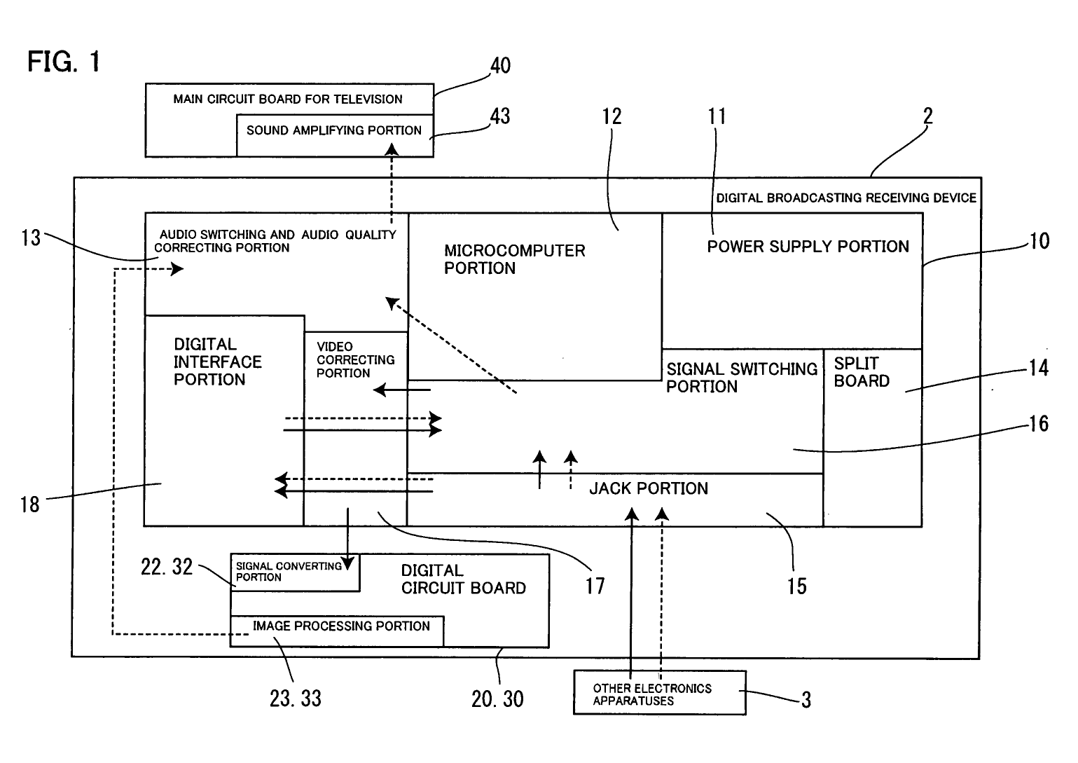

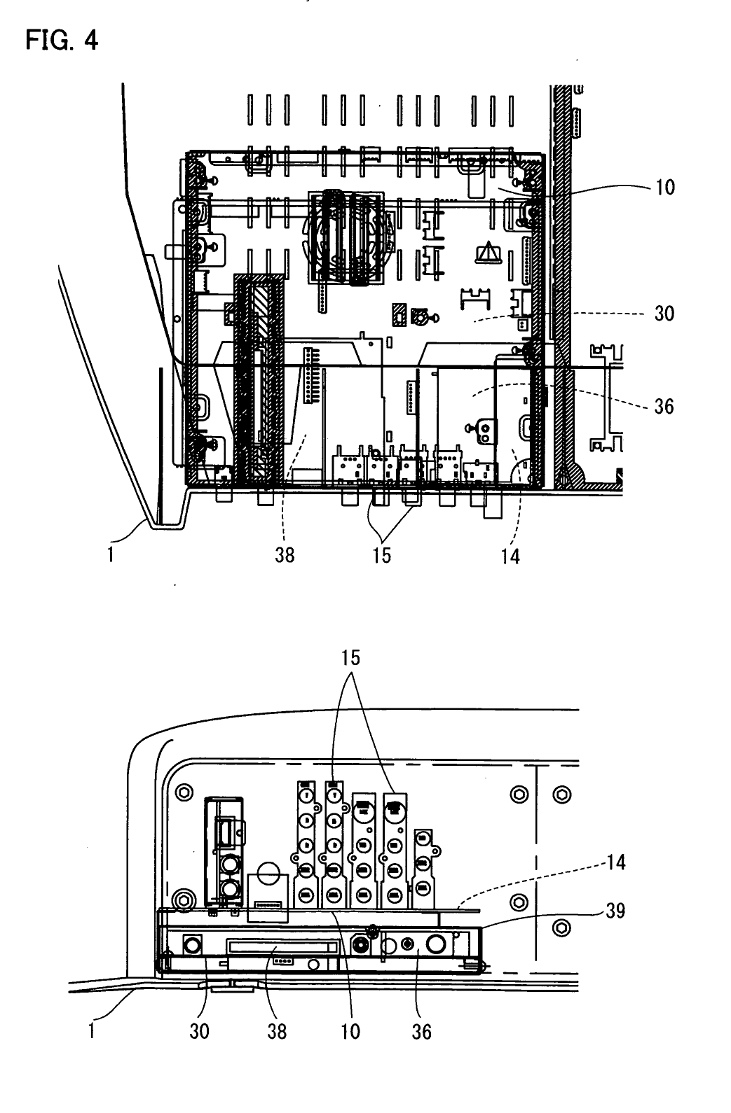

Hereunder, a description will be given by using FIGS. 1 to 6 as to preferred embodiments of the present invention. FIGS. 1, 2 and 3 are schematic diagrams relating to the common AV circuit board and digital broadcasting receiving device using it indicating a first embodiment of the present invention. FIGS. 4, 5 and 6 are schematic diagrams relating to the digital broadcasting receiving device capable of receiving the charging broadcast and a digital television capable of receiving the charging broadcast using the common AV circuit board indicating a second embodiment of the present invention. As a matter of course, it goes without saying that the present invention is easily applicable to those other than what is described in the embodiments to the extent that such applications are not against the gist of the present invention.

### First Embodiment

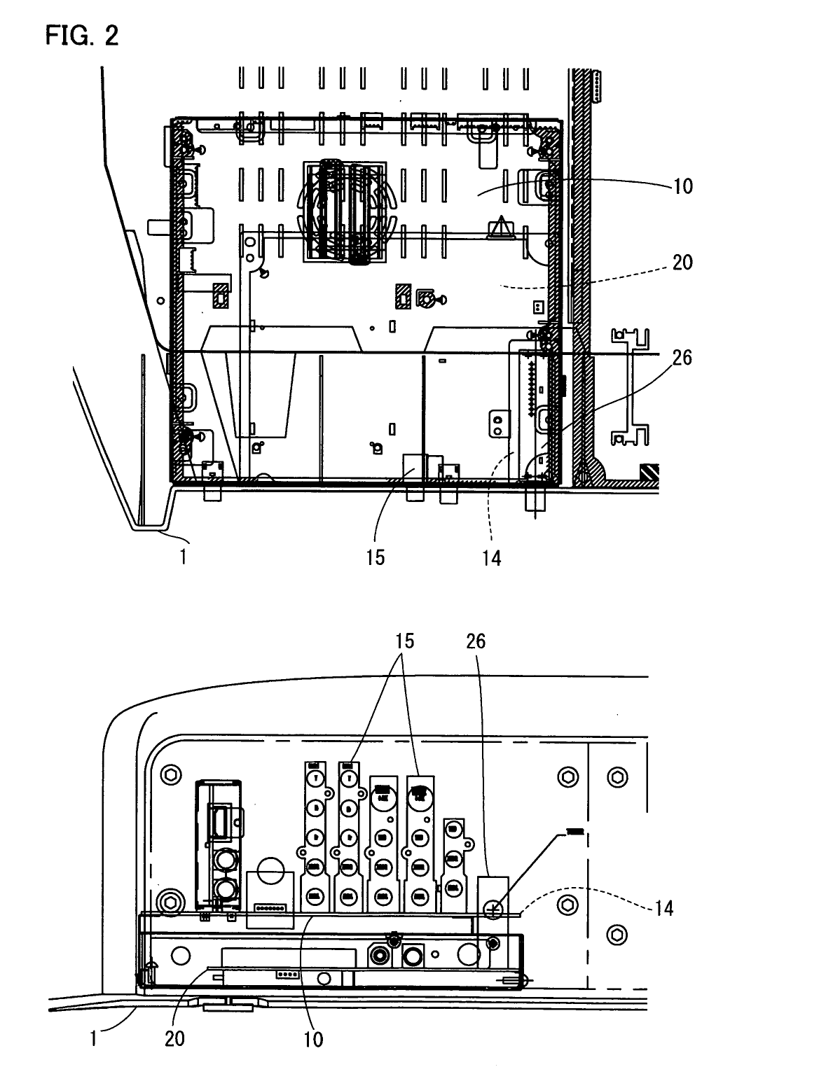

FIG. 2 show a part of the inside of a digital television 1 incapable of receiving the charging broadcast as schematic diagrams showing a positional relation in mounting an AV circuit board 10 having a split board 14 already divided and notched and having jacks mounted thereon and a digital circuit board 20 having a vertical tuner 26 thereon incapable of receiving the charging broadcast on the upside and downside. In FIG. 2, the digital circuit board 20 incapable of receiving the charging broadcast is placed on the down side of the AV circuit board 10, and the vertical analog/digital tuner 26 for converting received signals of analog broadcasting and digital broadcasting to analog video and audio signal and a digital video and audio signal is placed on a corner on a right front side of the digital circuit board 20. At a position on the corner on the right front side of the AV circuit board 10 and directly above the vertical analog/digital tuner 26, a broken leading line indicates that a separably placed split board 14 is separated and notched. FIG. 2 show that it is possible, by having the split board 14 divided and notched from the AV circuit board 10, to combine and place the digital circuit board 20 and AV circuit board 10 in two-layer placement with the digital circuit board 20 incapable of receiving a charging broadcast and having the vertical tuner 26 placed thereon on the downside and the AV circuit board 10 on the upside so as to have a circuit configuration by electrically connecting the digital circuit board 20 with the AV circuit board 10. It is also possible to have the vertical tuner 26 placed on the digital circuit board 20 on the downside incapable of receiving the charging broadcast projected from a notch position by separating the split board 14 indicated in the broken line so that a vertical space between the vertically placed AV circuit board 10 and digital circuit board 20 can be narrowed so as to save the space. The AV circuit board 10 has a jack portion 15 having multiple jacks to be used for connections with other unshown electronics apparatuses placed thereon, which allows the connections with other electronics apparatuses externally placed. Incidentally, the digital circuit board 20 incapable of receiving the charging broadcast uses an expensive multilayer board material as described in the conventional example, and so the vertical tuner 26 having small mounting area is placed in order to reduce the area using the multilayer board material as much as possible.

Next, an overview circuit configuration of the AV circuit board 10 will be described by referring to FIG. 1. In this embodiment shown in FIG. 1, a description will be given as to a digital interface portion 18, a video correcting portion 17 and a microcomputer portion 12 placeable on the AV circuit board 10, the digital circuit board 20 incapable of receiving the charging broadcast or the digital circuit board 20 capable of receiving the charging broadcast as an example of being placed on the AV circuit board 10. The AV circuit board 10 includes a power supply portion 11 for supplying power to mounted electronic components, a jack portion 15 having jacks used for connections with other electronics apparatuses 3, a digital interface portion 18 including a connection function for digital connections with the other electronics apparatuses 3, a signal switching portion 16 for selecting a predetermined video and audio signal from an analog video and audio signal directly inputted from the jack portion 15 and a digital video and audio signal inputted from the digital interface portion 18 after being inputted from the jack portion 15 to the digital interface portion 18, a video correcting portion 17 for correcting a video signal inputted from the signal switching portion 16, an audio switching and audio quality correcting portion 13 for selecting a predetermined audio signal from an analog audio signal and a digital audio signal inputted from the signal switching portion 16 and correcting audio quality, and a microcomputer portion 12 for controlling the portions. The AV circuit board 10 is compatible with multiple kinds of digital circuit boards 20 and 30 as to connections, and is capable of configuring multiple kinds of digital broadcasting receiving circuit by being combined with the digital circuit boards 20 and 30. The AV circuit board 10 has a separable split board 14 placed at a corner thereof. And even in the case of being mounted overlapping a component such as the vertical tuner 26 projecting on the upside as with the digital circuit board 20 incapable of receiving the charging broadcast placed in two-layer placement on the downside of the AV circuit board 10, the component projecting on the upside does not contact it because the split board 14 is separated and forms a notch. It also shows that they are combined in two-layer placement and electrically connected with the AV circuit board 10 on the upside so as to configure the circuit on the downside.

A flow of the signals on the AV circuit board 10 will be described by referring to FIG. 1. The analog and digital video and audio signals from the other electronics apparatuses 3 are inputted from the jack portion 15 consisting of multiple jacks, and the analog video and audio signal is selected by the signal switching portion 16 for selecting a predetermined one out of the signals inputted from the multiple jacks. As for the digital video and audio signal, a predetermined one is selected by the signal switching portion 16 after going through the digital interface portion 18 for the sake of making connections with the other electronics apparatuses 3. Thereafter, the video signal is corrected by the video correcting portion 17, and is conveyed to signal switching portions 22 and 32 of the aforementioned digital circuit boards 20 and 30. As for the audio signal, a predetermined one is selected out of the audio signals inputted from outside by the audio switching and audio quality correcting portion 13 so as to correct audio quality in a low-frequency range and a high-frequency range. The audio signals inputted from image processing portions 23 and 33 of the aforementioned digital circuit boards 20 and 30 are also processed by the audio switching and audio quality correcting portion 13 placed on the AV circuit board 10. For instance, if connected to a sound amplifying portion 43 of a main board for television 40 configuring a circuit of an unshown television, it is possible to have the audio signals amplified and outputted from an unshown speaker by the sound amplifying portion 43.

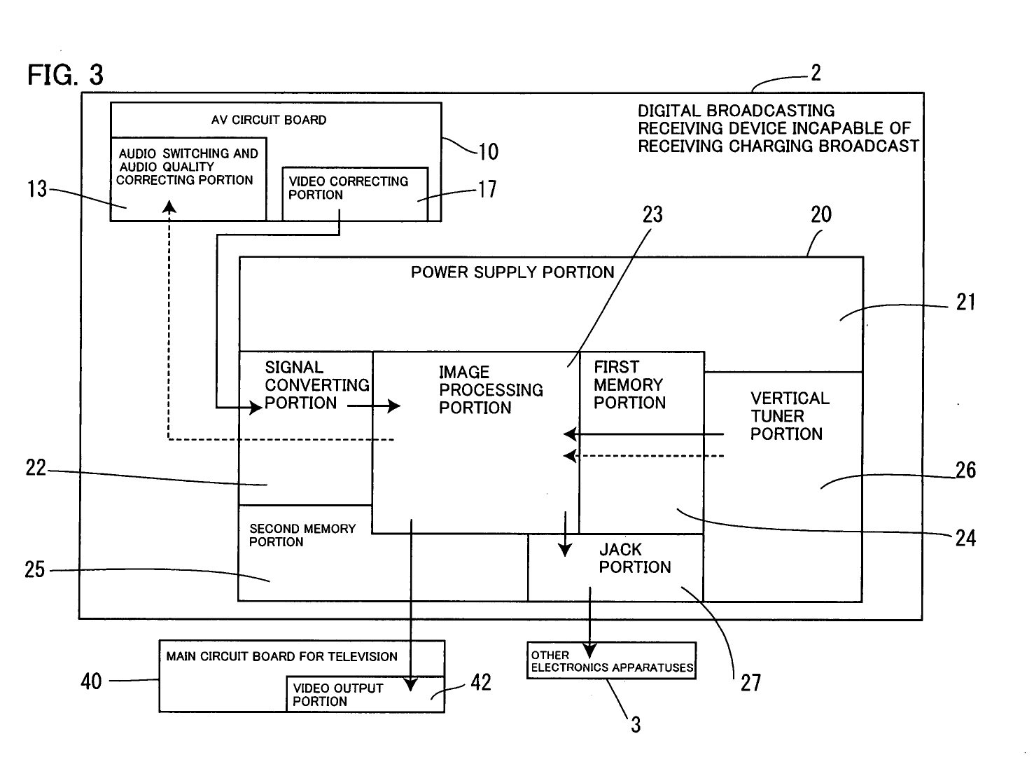

Next, an overview configuration of the digital circuit board incapable of receiving the charging broadcast will be described by referring to FIG. 3. In FIG. 3, the digital circuit board 20 incapable of receiving the charging broadcast includes a power supply portion 21 for supplying power to the digital circuit board 20, the vertical analog/digital tuner 26 for converting received signals of analog broadcasting and digital broadcasting to the analog video and audio signal and digital video and audio signal, a signal converting portion 22 for converting the analog video signal inputted from the video correcting portion 17 placed on the AV circuit board 10 to the digital video signal, an image processing portion 23 consisting of a circuit board generally called an MPEG board having a circuit based on the MPEG standard mounted thereon for decoding the video and audio signal and adjusting a size of an image of the video signal, a first memory 24 for storing an OS (Operating System) and software for managing a microcomputer, connecting it to a user and implementing its operation, a second memory 25 for replacing a work area of the software and video stored in the first memory 24 and a jack portion 27 having jacks for connections with other digital electronics apparatuses 3.

Next, the flow of the signals on the digital circuit board 20 incapable of receiving the charging broadcast will be described by referring to FIG. 3. The digital circuit board 20 incapable of receiving the charging broadcast shown in FIG. 3 has the vertical analog/digital tuner 26 placed on a lower right side thereof, where the received signals of analog broadcasting and digital broadcasting are converted to the analog video and audio signal and digital video and audio signal and conveyed to the image processing portion 23. The analog video signal inputted from the video correcting portion 17 placed on the AV circuit board 10 is converted to the digital video signal and conveyed to the image processing portion 23 by the signal converting portion 22. Subsequently, the image processing portion 23 decodes the video and audio signal and adjusts the size of the image of the video signal so that it is possible, by connecting it to a video output portion 42 placed on the main circuit board for television 40, to display the image on a display screen of the unshown television. It is also possible to supply the audio signal from the image processing portion 23 to the audio switching and audio quality correcting portion 13 placed on the AV circuit board 10 and also to the other electronics apparatuses 3 connected by the jack portion 27.

As described above, it is possible, by electrically connecting the digital circuit board 20 incapable of receiving the charging broadcast to the compatible and common AV circuit board 10, to easily obtain a digital broadcasting receiving device 2 incapable of receiving the charging broadcast configuring the digital broadcasting receiving circuit incapable of receiving the charging broadcast and the electronics apparatuses such as the television 1 including the digital broadcasting receiving circuit incapable of receiving the charging broadcast. When newly providing the digital broadcasting receiving device 2, it is only necessary to create a new digital circuit board by using the compatible and common AV circuit board 10 so as to easily obtain the new digital broadcasting receiving device and electronics apparatus having the common AV circuit board 10. Second Embodiment

Next, a description will be given by referring to FIGS. 4 to 6 as to a second embodiment of the present invention, which is a combination of the digital circuit board capable of receiving the charging broadcast and the compatible and common AV circuit board.

FIG. 4 show a part of the inside of the digital television 1 capable of receiving the charging broadcast as schematic diagrams showing a positional relation in mounting the AV circuit board and the digital circuit board capable of receiving the charging broadcast having a charging broadcast receiving portion placed thereon for the sake of receiving the charging broadcast on the upside and downside. In FIG. 4, the digital circuit board 30 capable of receiving the charging broadcast is placed on the downside of the AV circuit board 10, and the horizontal analog/digital tuner 36 for converting the received signals of analog broadcasting and digital broadcasting to the analog video and audio signal and digital video and audio signal is placed on the corner on the right front side of the digital circuit board 30 capable of receiving the charging broadcast. A charging broadcast receiving portion 38 is mounted to the left thereof. And the horizontal analog/digital tuner 36 and charging broadcast receiving portion 38 are enclosed with a shield 39 for shielding radiation noise radiated from the charging broadcast receiving portion 38. The AV circuit board 10 is on the upside of the digital circuit board 30 capable of receiving the charging broadcast, and a broken line indicates that the separably placed split board 14 is already separated and notched and the jacks capable of making connections with other unshown electronics apparatuses are mounted on the jack portion 15 on the front side. The digital circuit board 30 capable of receiving the charging broadcast needs to have the horizontal analog/digital tuner 36 and charging broadcast receiving portion 38 shielded with the shield 39 in order to shield the aforementioned radiation noise. The charging broadcast receiving portion 38 is in a horizontally wide shape and horizontally placed on the digital circuit board 30 capable of receiving the charging broadcast. Therefore, the horizontal analog/digital tuner 36 placed together is also horizontally placed so as to be integrally shielded with the shield 39.

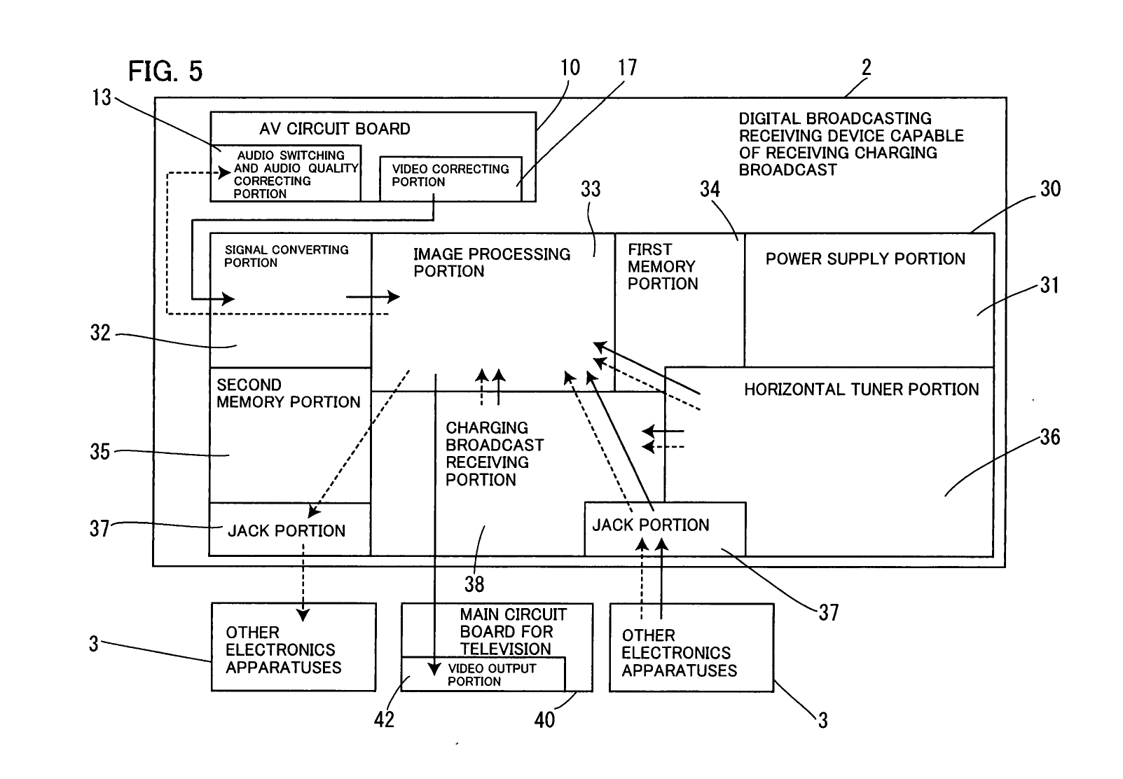

Next, a description will be given as to an overview configuration of the digital circuit board capable of receiving the charging broadcast shown in FIG. 5. In FIG. 5, the digital circuit board 30 capable of receiving the charging broadcast includes a power supply portion 31 for supplying power to the digital circuit board 30, the horizontal analog/digital tuner 36 for converting the received signals of analog broadcasting and digital broadcasting to the analog video and audio signal and digital video and audio signal, a signal converting portion 32 for converting the analog video signal inputted from the video correcting portion 17 placed on the AV circuit board 10 to the digital video signal, an image processing portion 33 consisting of a circuit board generally called an MPEG board having a circuit based on the MPEG standard mounted thereon for decoding the video and audio signal and adjusting the size of the image of the video signal, a first memory 34 for storing the OS and software, a second memory 35 for replacing the work area of the software and video stored in the first memory 34 and a jack portion 37 having the jacks for connections with the other digital electronics apparatuses 3. It also has a charging broadcast receiving portion 38 for decoding the charging broadcast, including an inserting portion of a user card for the charging broadcast in order to receive the charging broadcast.

Next, the flow of the signals on the digital circuit board 30 capable of receiving the charging broadcast will be described by referring to FIG. 5. The digital circuit board 30 capable of receiving the charging broadcast shown in FIG. 5 has the horizontal analog/digital tuner 36 placed on the lower right side thereof, where the received signals of the received analog broadcasting and digital broadcasting are converted to the analog video and audio signal and digital video and audio signal and is conveyed to the charging broadcast receiving portion 38 and decoded and then conveyed to the image processing portion 33 in the case of the charging broadcast or directly conveyed to the image processing portion 33 if other than the charging broadcast. The multiple jacks allowing connections with the other electronics apparatuses 3 are placed in the jack portion 37 to allow the video and audio signal to be inputted. The video and audio signal inputted from the jack portion 37 is conveyed to the image processing portion 33. Furthermore, the video signal inputted from the video correcting portion 17 placed on the AV circuit board 10 is converted from the analog video signal to the digital video signal by the signal converting portion 32 and conveyed to the image processing portion 33. The image processing portion 33 decodes these video and audio signals and adjusts the size of the image of the video signal so that it is possible, by connecting to the video output portion 42 placed on the main board for television 40, to display the image of the video signal on a display screen of the unshown television. It is possible to supply the audio signal to the other electronics apparatuses 3 connected by the jack portion 37 or supply it from the image processing portion 23 to the audio switching and audio quality correcting portion 13 placed on the AV circuit board 10.

As described above, it is possible, by electrically connecting the digital circuit board 30 capable of receiving the charging broadcast to the compatible and common AV circuit board 10, to easily obtain a digital broadcasting receiving device 3 capable of receiving the charging broadcast configuring the digital broadcasting receiving circuit capable of receiving the charging broadcast and the electronics apparatuses such as the digital television 1 including the digital broadcasting receiving circuit. When newly providing the digital broadcasting receiving device 2, it is only necessary to create a new digital circuit board by using the compatible and common AV circuit board 10 so as to easily obtain the new digital broadcasting receiving device and electronics apparatus having the common AV circuit board.

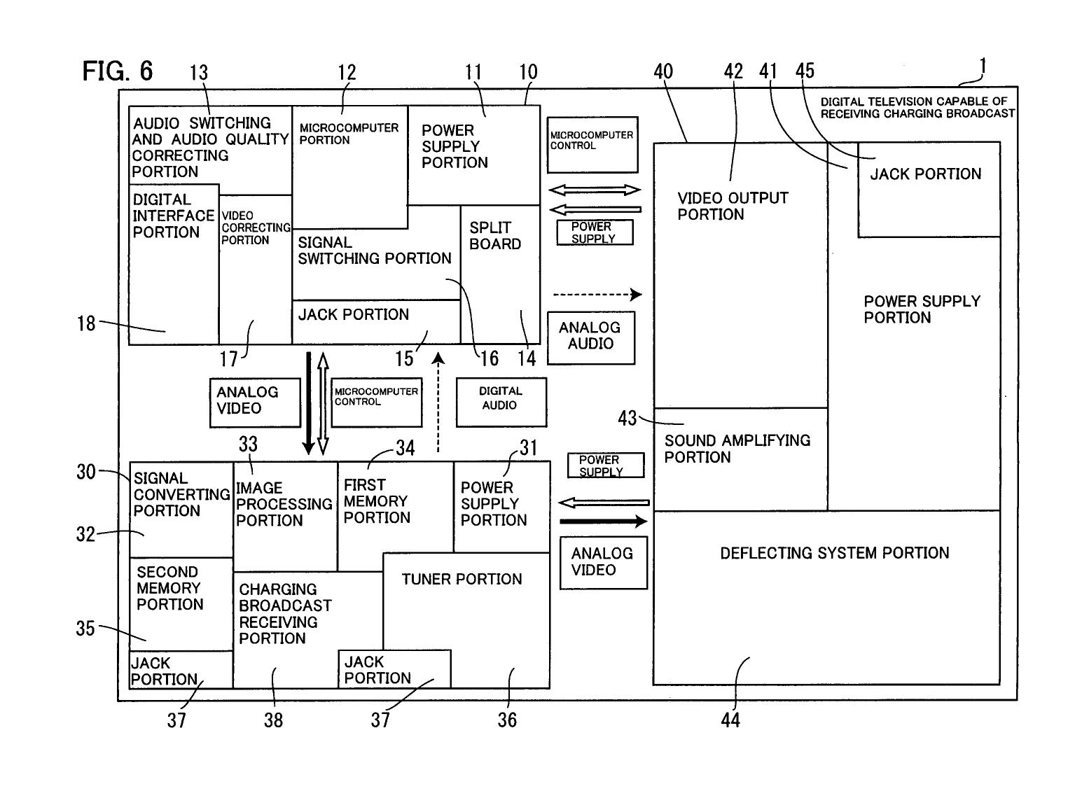

Next, a description will be given by referring to FIG. 6 as to the digital television 1 capable of receiving the charging broadcast having the digital circuit board capable of receiving the charging broadcast and the common AV circuit board placed thereon. The digital television 1 has the main circuit board for television 40, the common AV circuit board 10 and the digital circuit board 30 capable of receiving the charging broadcast placed therein. The main circuit board for television 40 has a power supply portion 41 for supplying power to the inside of the digital television 1, the video output portion 42 for outputting the video signal to display the image on the unshown display screen, the sound amplifying portion for amplifying the audio signals and outputting them from the unshown speaker, a deflecting system portion 44 for deflecting the video signal outputted from the video output portion 42 to display it on the unshown display screen, and a jack portion 45 for allowing connections with the other unshown electronics apparatuses externally placed. The power is supplied from the power supply portion 41 of the main circuit board for television 40 to the power supply portion 11 of the AV circuit board 10 and the power supply portion 31 of the digital circuit board 30 capable of receiving the charging broadcast. Operations of the main circuit board for television 40 and the digital circuit board 30 capable of receiving the charging broadcast are controlled by the microcomputer portion 12 placed on the AV circuit board 10. To describe it from the flow of the signals, the digital audio signal is conveyed from the digital circuit board 30 capable of receiving the charging broadcast to the AV circuit board 10 to be analog-converted and become the analog audio signal so as to be conveyed to the main circuit board for television 40. The digital video signal is analog-converted by the digital circuit board 30 capable of receiving the charging broadcast, and the analog video signal is conveyed to the main circuit board for television 40. The digital circuit board placed in the digital television 1 described here does not have to be the digital circuit board 30 capable of receiving the charging broadcast, but it may be replaced by the digital circuit board 20 incapable of receiving the charging broadcast and placed therein. Therefore, it is also possible to place the digital circuit board 20 incapable of receiving the charging broadcast so as to obtain the digital television incapable of receiving the charging broadcast.

As described above, it is possible to combine the compatible and common AV circuit board 10 with the digital circuit board incapable of receiving the charging broadcast and thereby render it as a digital circuit configuration incapable of receiving the charging broadcast so as to obtain the digital broadcasting receiving device 2 incapable of receiving the charging broadcast. It is also possible, by combining the digital circuit configuration with the main circuit board for television 40, to easily obtain the electronics apparatus such as the digital television 1 having the digital broadcasting receiving circuit incapable of receiving the charging broadcast. It is also possible, by combining it with the digital circuit board 30 capable of receiving the charging broadcast and thereby rendering it as the digital circuit configuration, to obtain the digital broadcasting receiving device 2 capable of receiving the charging broadcast. And it is further possible, by combining the digital circuit configuration capable of receiving the charging broadcast with the main circuit board for television 40, to easily obtain the electronics apparatus such as the digital television 1 capable of receiving the charging broadcast having the digital broadcasting receiving circuit capable of receiving the charging broadcast. When newly providing the digital broadcasting receiving device 2, it is only necessary to create a new digital circuit board by using the compatible and common AV circuit board 10 so as to easily obtain the new digital broadcasting receiving device 2 and electronics apparatus having the common AV circuit board. Furthermore, it is possible, for the digital broadcasting receiving device 2 capable of receiving the digital broadcast, to obtain the AV circuit board 10 usable in common for the digital circuit board 30 capable of receiving the charging broadcast and the digital circuit board 20 incapable of receiving the charging broadcast. When newly providing the digital broadcasting receiving device, it is thus possible, just by designing and producing a new digital circuit board based on the compatible AV circuit board usable in common, to eliminate the need for a design load for designing multiple kinds of AV circuit board 10, a parts management load due to increased kinds of electronic components, a mounting load for mounting the multiple kinds of AV circuit board 10, and further a quality control load for controlling and maintaining quality of the multiple kinds of AV circuit board 10 and reduce an assembly work load due to combinations of the multiple kinds of AV circuit board 10 and multiple kinds of digital circuit boards 20 and 30 so as to reduce costs due to the loads. This embodiment shows an example in which the digital interface portion 18, video correcting portion 17 and microcomputer portion 12 are placed on the AV circuit board 10. It is also possible, however, to place them on the digital circuit board 20 incapable of receiving the charging broadcast and the digital circuit board 30 capable of receiving the charging broadcast.

The embodiments were described above. However, the present invention is not limited to the embodiments but various deformed embodiments are possible within the gist of the present invention. For instance, the circuit configurations of the AV circuit board 10, the digital circuit board 20 incapable of receiving the charging broadcast and the digital circuit board 30 capable of receiving the charging broadcast have only to be in a state capable of receiving the desired digital broadcasting. The placement of the split board 14 on the AV circuit board 10 is not limited to the embodiments but may be appropriately selected.

The effect of the present invention is as follows.

According to an invention of the first aspect, the digital broadcasting receiving device and electronics apparatus having a common AV circuit board can combine and connect multiple kinds of digital circuit board with the AV circuit board including a power supply portion for supplying power to mounted electronic components, a jack portion having jacks used for connections with other electronics apparatuses, a signal switching portion for selecting a predetermined video and audio signal from an analog video and audio signal and a digital video and audio signal inputted from the jack portion, and an audio switching portion for selecting a predetermined audio signal from an analog audio signal and a digital audio signal inputted from the signal switching portion so as to configure multiple kinds of digital broadcasting receiving circuit; and the AV circuit board has a separable split board placed at a corner thereof, and in the case of configuring a circuit in two-layer placement with the digital circuit board incapable of receiving a charging broadcast and having a vertical tuner placed thereon on a downside and the AV circuit board on an upside, they can be placed and combined to have the vertical tuner placed on the digital circuit board on the downside incapable of receiving the charging broadcast projected from a notch portion at which the split board is separated and electrically connected for circuit configuration so as to configure the digital broadcasting receiving circuit incapable of receiving the charging broadcast. It is possible to combine and electrically connect a digital circuit board including a charging broadcast receiving portion and having a horizontal tuner placed thereon capable of receiving the charging broadcast with the AV circuit board having the split board to overlap each other so as to configure the digital broadcasting receiving circuit capable of receiving the charging broadcast. The digital interface portion including a connection function for digital connections with other electronics apparatuses, video correcting portion for correcting a video signal inputted from the signal switching portion, and microcomputer portion for controlling the portions are placeable on one of the AV circuit board, the digital circuit board incapable of receiving the charging broadcast and the digital circuit board capable of receiving the charging broadcast so as to reduce restrictions on circuit configuration in designing the multiple circuit boards. Furthermore, it is possible, on the receiving device for receiving the digital broadcasting, to obtain the AV circuit board usable in common for the digital circuit board incapable of receiving the charging broadcast and the digital circuit board capable of receiving the charging broadcast. When newly providing the digital broadcasting receiving device, it is only necessary to design and produce a new digital circuit board based on a compatible and commonly usable AV circuit board. Thus, it is possible to eliminate the need for a design load for designing the multiple kinds of AV circuit board, a parts management load due to increased kinds of electronic components, a mounting load for mounting the multiple kinds of AV circuit board, and further a quality control load for controlling and maintaining quality of the multiple kinds of AV circuit board and reduce an assembly work load due to combinations of the multiple kinds of AV circuit board and the multiple kinds of digital circuit board so as to reduce the costs due to the loads.

According to an invention of the second aspect, the digital circuit board incapable of receiving the charging broadcast includes: a power supply portion for supplying power to the digital circuit board; a vertical analog/digital tuner for converting received signals of analog broadcasting and digital broadcasting to the analog video and audio signal and digital video and audio signal; a signal converting portion for converting the analog video signal inputted from the video correcting portion placed on the AV circuit board to the digital video signal; an image processing portion for decoding the video and audio signal of the digital broadcasting and adjusting a size of an image of the video signal; a first memory used by the image processing portion to store an OS and software; a second memory for replacing a work area of the software and video stored in the first memory; and a jack portion having jacks used for connections with other digital electronics apparatuses placed thereon so as to be electrically connected to the AV circuit board and thereby easily obtain the digital broadcasting receiving device and electronics apparatus incapable of receiving the charging broadcast configuring the digital broadcasting receiving circuit. When newly providing the digital broadcasting receiving device, it is only necessary to create a new digital circuit board by using the compatible and common AV circuit board so as to easily obtain the new digital broadcasting receiving device and electronics apparatus having the common AV circuit board.

According to an invention of a third aspect, the digital circuit board capable of receiving the charging broadcast includes: a power supply portion for supplying power to the digital circuit board; a horizontal analog/digital tuner for converting received signals of analog broadcasting and digital broadcasting to the analog video and audio signal and digital video and audio signal; a charging broadcast receiving portion for decoding the charging broadcast including an inserting portion of a user card for the charging broadcast; a signal converting portion for converting an analog video signal inputted from a video correcting portion placed on the AV circuit board to a digital video signal; an image processing portion for decoding the video and audio signal of the digital broadcasting and adjusting a size of an image of the video signal; a first memory used by the image processing portion to store an OS and software; a second memory for replacing a work area of the software and video stored in the first memory; and a jack portion having jacks used for connections with other digital electronics apparatuses placed thereon so as to be electrically connected to the AV circuit board and thereby configure the digital broadcasting receiving circuit capable of receiving the charging broadcast. Thus, it is possible to easily obtain the digital broadcasting receiving device and electronics apparatus having the common AV circuit board capable of receiving the charging broadcast.

What is claimed is:

1. A digital broadcasting receiving device and an electronics apparatus having a common AV circuit board, wherein:
multiple kinds of digital circuit board are combined and connected with the AV circuit board including a power supply portion for supplying power to mounted electronic components, a jack portion having jacks used for connections with other electronics apparatuses, a signal switching portion for selecting a predetermined video and audio signal from an analog video and audio signal and a digital video and audio signal inputted from the jack portion, and an audio switching portion for selecting a predetermined audio signal from an analog audio signal and a digital audio signal inputted from the signal switching portion so as to configure multiple kinds of digital broadcasting receiving circuit; and
the AV circuit board has a separable split board placed at a corner thereof, and in the case of configuring a circuit in two-layer placement with the digital circuit board incapable of receiving a charging broadcast and having a vertical tuner placed thereon on a downside and the AV circuit board on an upside, they are placed and combined to have the vertical tuner placed on the digital circuit board on the downside incapable of receiving the charging broadcast projected from a notch portion at which the split board is separated and electrically connected for circuit configuration so as to configure the digital broadcasting receiving circuit incapable of receiving the charging broadcast; and
a digital circuit board including a charging broadcast receiving portion and having a horizontal tuner placed thereon capable of receiving the charging broadcast is combined and electrically connected with the AV circuit board having the split board to overlap each other so as to configure the digital broadcasting receiving circuit capable of receiving the charging broadcast; and
a digital interface portion including a connection function for digital connections with other electronics apparatuses, a video correcting portion for correcting a video signal inputted from the signal switching portion and a microcomputer portion for controlling the portions are placeable on one of the AV circuit board, the digital circuit board incapable of receiving the charging broadcast and the digital circuit board capable of receiving the charging broadcast.

2. The digital broadcasting receiving device and electronics apparatus having a common AV circuit board according to claim 1, wherein:
the digital circuit board incapable of receiving the charging broadcast comprises:
a power supply portion for supplying power to the digital circuit board;
a vertical analog/digital tuner for converting received signals of analog broadcasting and digital broadcasting to the analog video and audio signal and digital video and audio signal;
a signal converting portion for converting the analog video signal inputted from the video correcting portion placed on the AV circuit board to the digital video signal;
an image processing portion for decoding the video and audio signal of the digital broadcasting and adjusting a size of an image of the video signal;
a first memory used by the image processing portion to store an OS and software;
a second memory for replacing a work area of the software and video stored in the first memory; and
a jack portion having jacks used for connections with other digital electronics apparatuses placed thereon so as to be electrically connected to the AV circuit board and thereby configure the digital broadcasting receiving circuit incapable of receiving the charging broadcast.

3. The digital broadcasting receiving device and electronics apparatus having a common AV circuit board according to claim 1, wherein:
the digital circuit board capable of receiving the charging broadcast comprises:
a power supply portion for supplying power to the digital circuit board;
a horizontal analog/digital tuner for converting received signals of analog broadcasting and digital broadcasting to the analog video and audio signal and digital video and audio signal;
a charging broadcast receiving portion for decoding the charging broadcast including an inserting portion of a user card for the charging broadcast;
a signal converting portion for converting an analog video signal inputted from the video correcting portion placed on the AV circuit board to a digital video signal;
an image processing portion for decoding the video and audio signal of the digital broadcasting and adjusting a size of an image of the video signal;
a first memory used by the image processing portion to store an OS and software;
a second memory for replacing a work area of the software and video stored in the first memory; and
a jack portion having jacks used for connections with other digital electronics apparatuses placed thereon so as to be electrically connected to the AV circuit board and thereby configure the digital broadcasting receiving circuit capable of receiving the charging broadcast.
